(19) United States
(12) Patent Application Publication
(10) Pub. No.: US 2015/0220949 A1
(43) Pub. Date: Aug. 6, 2015

(54) SYSTEMS AND METHODS FOR GENERATING AND COLLECTING SURVEYS

(71) Applicant: THE NPD GROUP, INC., Port Washington, NY (US)

(72) Inventors: David B. Pinsley, Great Neck, NY (US); Brian Reismiller, Melville, NY (US); Yogesh Soin, Clemmons, NC (US)

(73) Assignee: THE NPD GROUP, INC., Port Washington, NY (US)

(21) Appl. No.: 14/174,194

(22) Filed: Feb. 6, 2014

(51) Int. Cl. G06Q 30/02

(52) U.S. Cl. CPC G06Q 30/0203

(57) ABSTRACT

Various embodiments are provided generally relating to providing surveys for mobile devices. In some embodiments, one or more media items may be received from a mobile device by an external device. A survey may be selected based on receiving the one or more media items. The survey may also be provided to the mobile device. For example, a mobile device may send a photograph of a meal to the external device, and a survey may be selected based on the received photograph.

### FIELD OF THE INVENTION

This generally relates to systems and methods for generating and providing surveys using media items sent from a mobile device.

### BACKGROUND OF THE INVENTION

While surveys have been used for years to understand all types of behavioral trends and marketing questions, the ways that surveys have, in general, been distributed and collected have remained, for the most part, fairly consistent. Within the last decade or so, surveys had leapt into the modern age with users taking part via their desktop and/or laptop computers to access and respond to survey questions. Over the last few years in particular, as and portable electronic device technology and capability has rapidly improved and expanded, survey takers and survey generation and collection companies have increasingly started to use mobile devices to receive and obtain responses to surveys. However, this has posed new challenges to the survey industry, as the “real estate” available on smartphones and other mobile devices may often times be much less than that of desktop and/or laptop computer.

Furthermore, survey participants, or panelists, now expect and desire surveys to take less time to complete. This issue can be compounded by the display constraints previously mentioned that are often associated with mobile devices. Additionally, with the “on the go” lifestyle afforded by mobile devices, obtaining detailed user responses, if not responses at all, has becoming increasingly challenging.

### SUMMARY OF THE INVENTION

Systems, methods, and non-transitory computer readable media for developing improved techniques to promote survey participation using mobile devices are provided. Systems typically include one or more processor, a display, communications components, and memory containing instructions. In some embodiments, additional components such as power supplies, storage, and/or input circuitry may be included.

Such methods may include receiving one or more media items from a mobile device by an external device, such as a server. The one or more media items may be transmitted over a network and may include, for example, photographs, videos, and/or audio recordings. In response to receiving the media item(s), a survey may be selected by the external device. In some embodiments, the selected survey may include one or more survey questions. However, in some embodiments the selected survey may include the received media item(s) and one or more survey questions. The external device may provide the mobile device with the generated survey. In some embodiments, the selected survey may be provided to the mobile device via a URL link. In some embodiments, the external device may receive a response to one or more of the survey questions included within the selected survey. In still further embodiments, the one or more survey questions may be selected based on the media item(s) received by the external device.

Such methods may also include obtaining one or more media items using a mobile device, such as a smartphone, tablet, and/or cellphone. For example, a mobile device including a camera may capture a photograph of an event or image. The mobile device may provide the obtained media item to an external device such as, for example, a server. The mobile device may receive the provided media item(s) from the external device, along with one or more survey question in a selected survey. In some embodiments, the mobile device may receive the provided media item(s) from the external device along with a link to the selected survey. The survey question(s) may, in some embodiments, be selected based on the provided media item(s). The mobile device may display the received media item(s) and survey question(s) and/or just the survey question(s) on a display screen of the mobile device. A response may then be sent to the external device for the one or more received survey questions.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a block diagram of a system used in accordance with various embodiments;

FIG. 2 is a block diagram of a device used in accordance with various embodiments;

FIG. 3A is an illustrative diagram of a display of a mobile device used in accordance with various embodiments;

FIG. 3B is an illustrative diagram of a display of a mobile device used in accordance with various embodiments;

FIG. 4A is another illustrative diagram of a display of a mobile device in accordance with various embodiments;

FIG. 4B is yet another illustrative diagram of a display of a mobile device in accordance with various embodiments;

FIG. 5 is an illustrative flowchart of a process for generating surveys in accordance with various embodiments;

FIG. 6 is an illustrative flowchart of a process for displaying a generated survey on a mobile device in accordance with various embodiments;

FIG. 7 is an illustrative flowchart of a process for responding to a survey in accordance with various embodiments.

### DETAILED DESCRIPTION OF THE INVENTION

The present invention may take form in various components and arrangements of components, and in various techniques, methods, or procedures and arrangements of steps. The referenced drawings are only for the purpose of illustrated embodiments, and are not to be construed as limiting the present invention. Various inventive features are described below that can each be used independently of one another or in combination with other features.

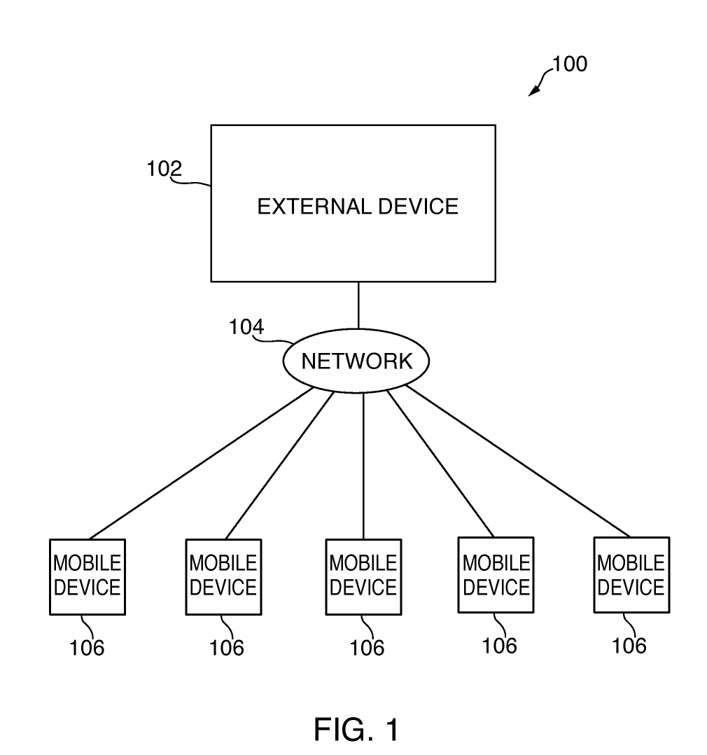

FIG. 1 is a block diagram of a system that may be utilized in accordance with various embodiments. System 100 may include external device 102 and one or more mobile devices 106. External device 102 and mobile device(s) 106 may communicate with each other over network 104. Although only five mobile devices 106 and one external device 102 are shown in FIG. 1 for system 100, persons of ordinary skill in the art will recognize that any number of external devices and/or mobile devices may be included, and the use of five mobile devise and one external device is merely exemplary.

In some embodiments, external device 102 may be a server, or combination of servers, capable of facilitating communications with one or more of mobile devices 106 via network 104. Mobile devices 106 may send and/or receive data with external device 102 across network 104. Similarly, mobile devices 106 may correspond to any device capable of communicating with external device 102 and/or any other mobile device using network 104. External device 102 may send and/or receive data from mobile devices 106 across network 104.

Network 104 may be any network, combination of networks, or network devices that transmit and/or carry data communications. For example, various network types may include, but are not limited to, local area networks (“LAN”), wide area networks (“WAN”), telephone networks, wireless networks, point-to-point networks, star networks, token ring networks, hub networks, or any other network configuration, or any combination thereof. Network 104 may support any number of protocols including, but not limited to, Wi-Fi (e.g., a 802.11 protocol), Bluetooth®, radio frequency systems (e.g., 900 MHz, 1.4 GHz, and 5.6 GHz communication systems), cellular networks (e.g., GSM, AMPS, GPRS, CDMA, EV-DO, EDGE, 3GSM, DECT, IS-136/TDMA, iDEN, LTE or any other suitable cellular network protocol), infrared, TCP/IP (e.g., any of the protocols used in each of the TCP/IP layers), HTTP, BitTorrent, FTP, RTP, RTSP, SSH, Voice over IP (VOIP), any other communication protocol, or any combination thereof. In some embodiments, network 104 can provide wired communications paths for mobile devices 106. In other embodiments, network 104 can provide wireless communications paths, while in other embodiments a combination of wired and wireless communications may be utilized.

Mobile devices 106 may correspond to any electronic device that is capable of communicating across network 104 with external device 102 and/or with one or more additional mobile devices 106. Various types of mobile devices may include, but are not limited to, portable media players, cellular telephones, smartphones, pocket-sized personal computers, personal digital assistants (“PDAs”), desktop computers, laptop computers, and/or tablet computers.

Although examples of embodiments may be described for a user-server model with a server servicing requests of one or more user applications, persons of ordinary skill in the art will recognize that other models (e.g., peer-to-peer) are available for implementation of the described embodiments. For example, a user application executed on mobile device 106 may handle requests independently and/or in conjunction with external device 102.

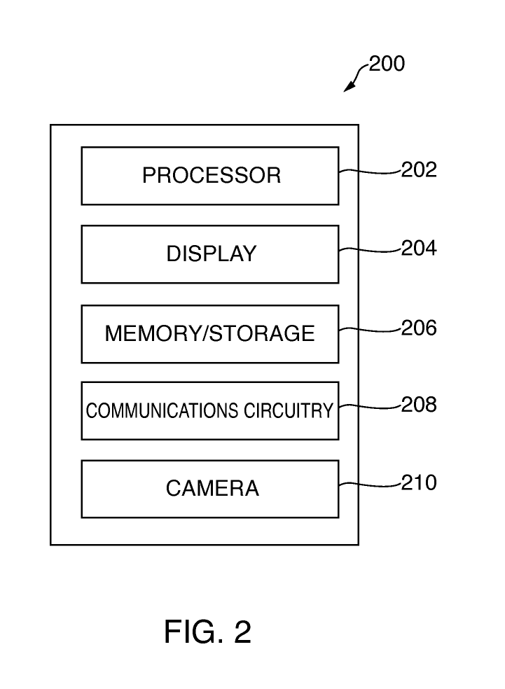

FIG. 2 is a schematic view of an illustrative device that may be used in accordance with various embodiments. Device 200 may, in some embodiments, correspond to one of the mobile devices 106 shown in FIG. 1. In some embodiments, device 200 may correspond to external device 102. It should be understood to persons of ordinary in the art that device 200 is merely one example of a device that can be implemented within a server-device system, and it is not limited to being only one part of the system. Furthermore, one or more components included within device 200 may be added or omitted without departing from the spirit of the invention.

In some embodiments, device 200 may include processor 202, display 204, memory/storage 206, communications circuitry 208, and camera 210. In some embodiments, one or more of the previously mentioned components may be combined or omitted, and/or one or more components may be added. For example, memory/storage 206 may be a single element for storing data and/or may be separate components (e.g., a storage component and a memory component). As another example, device 200 may additionally include a power supply, an output interface, a bus connector, or any other additional component. In some embodiments, device 200 may include multiple instances of one or more of the components included therein. However, for the sake of simplicity only one of each component has been shown in FIG. 2.

Processor 202 may include any processing circuitry, such as one or more processors capable of controlling the operations and functionality of device 200. In some embodiments, processor 202 may facilitate communications between various components within device 202.

Processor 202 may run the device's operation system, applications resident on the device, firmware applications, media applications, and/or any other type of application, or any combination thereof. In some embodiments, processor 202 may process one or more inputs detected by device 200 and perform one or more actions in response to the detected inputs.

Display 204 may include any type of display capable of presenting content to a user and/or on a mobile device. Display 204 may be any size and may be located on one or more regions/sides of device 200. For example, display 204 may fully occupy a first side of device 200, or may occupy a portion of the first side. Various display types may include, but are not limited to, liquid crystal displays (“LCD”), monochrome displays, color graphics adapter (“CGA”) displays, enhanced graphics adapter (“EGA”) displays, variable graphics array (“VGA”) displays, or any other display type, or any combination thereof. In some embodiments, display 204 may be a touch screen and/or an interactive display. In some embodiments, the touch screen may include a multi-touch panel coupled to processor 202. In some embodiments, display 204 may be a touch screen and may include a capacitive sensing panels.

Memory/storage 206 may be one component combining both memory and storage, or each may be individual components within device 200. In some embodiments, storage 206 may include one or more storage mediums. Various types of storage mediums may include, but are not limited to, hard-drives, solid state drives, flash memory, permanent memory (e.g., ROM), or any other storage type, or any combination thereof. Any form of data or content may be stored within memory/storage 206, such as photographs, music files, videos, contact information, applications, documents, or any other file, or any combination thereof. Memory 206 may include cache memory, semi-permanent memory (e.g., RAM), or any other memory type, or any combination thereof. In some embodiments, memory 206 may be used in place of and/or in addition to external storage for storing data on device 200.

Communications circuitry 208 may include any circuitry capable of connecting to a communications network (e.g., network 104) and/or transmitting communications (voice or data) to one or more devices (e.g., mobile devices 106) and/or servers (e.g., external device 102). Communications circuitry 208 may interface with the communications network using any suitable communications protocol including, but not limited to, Wi-Fi (e.g., 802.11 protocol), Bluetooth®, radio frequency systems (e.g., 900 MHz, 1.4 GHz, and 5.6 GHz communications systems), infrared, GSM, GSM plus EDGE, CDMA, quadband, VOIP, or any other protocol, or any combination thereof.

Camera 210 may correspond to any image capturing component capable of capturing images and/or videos. For example, camera 210 may capture photographs, sequences of photographs, rapid shots, videos, or any other type of image, or any combination thereof. In some embodiments, device 200 may include one or more instances of camera 210. For example, device 200 may include a front-facing camera and a rear-facing camera. Although only one camera is shown in FIG. 2 to be within device 200, it should be understood by persons of ordinary skill in the art that any number of cameras, and any camera type may be included.

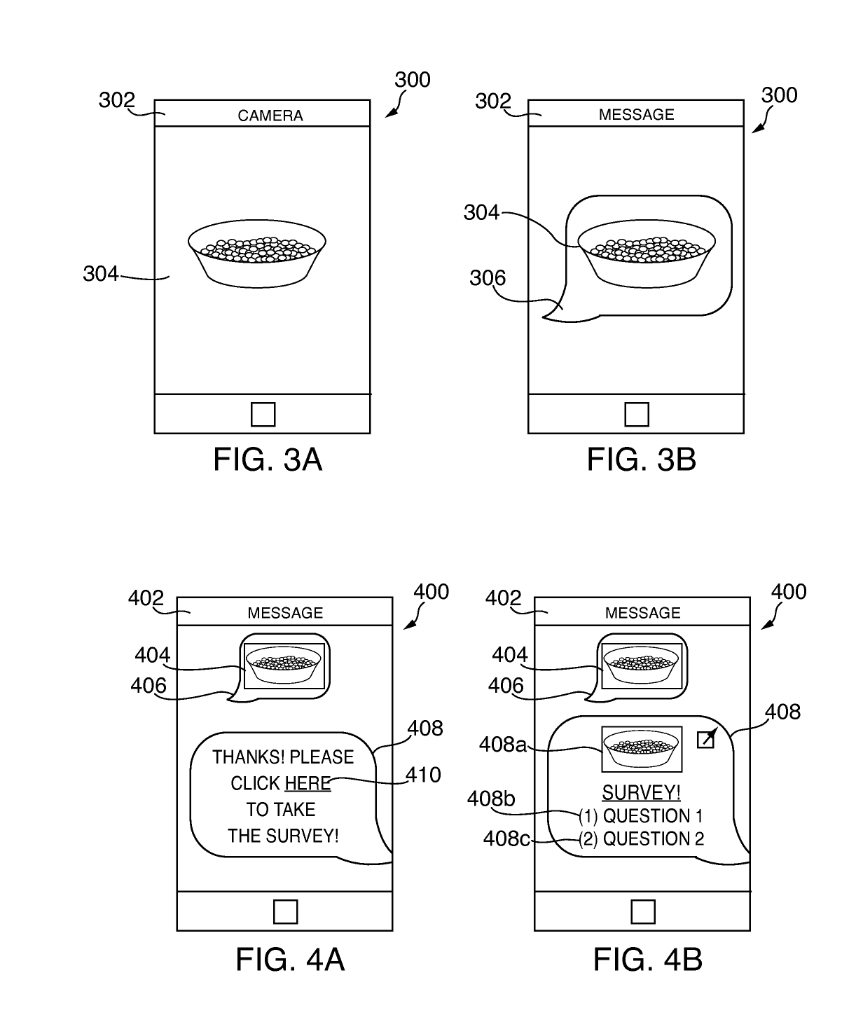

FIG. 3A is an illustrative diagram of a display screen presented on a user's mobile device in accordance with various embodiments. In some embodiments, display 300 may present an image. In some embodiments, display 300 may display an output from a camera incorporated within a user's mobile device (e.g., mobile device 106). For example, a user may take a photograph (e.g., a photograph of a meal), which may be shared with one or more contacts and/or services (e.g., a survey generation and compilation service).

Media item 304 may, in some embodiments, be any image captured by a camera (e.g., camera 210 of FIG. 2) while in camera mode 302. Camera mode 302 may be selected by the user using any suitable gesture and/or input. For example, a user may invoke a camera button on the user's mobile device (e.g., device 200), which may open a camera application. In some embodiments, the user may be within another program (e.g., an email application, a messaging application, etc.), which may allow the user to capture an image and/or video from within that application using the camera resident on the mobile device.

In some embodiments, the user may be asked to take a picture of certain events and/or objects. For example, a user may be a member of a survey panel and/or sign up to be part of a survey. In some embodiments, users may be consumer participants for an ongoing and/or single event survey project. The consumer participants may be new participants or previously recruited participants. The user may be asked to capture images, audio recordings, and/or videos corresponding to certain events that may be associated with one or more survey topics for which a survey may be generated for.

FIG. 3B is an illustrative diagram of a display for transmitting one or more media items in accordance with various embodiments. The user may transmit the media item(s) using any suitable communications mode. For example, display 300 may show messaging mode 306 displayed on a display component (e.g., display 204) of a user's mobile device (e.g., mobile device 106). Various communications modes may include MMS, SMS, instant messages, email, one or more third party application messages, and/or a survey application resident on the user device, or any combination thereof. In some embodiments, the media item(s) may be an attachment transmitted using one or more of the previously described communications modes (e.g., an attachment to an email).

In some embodiments, once a media item, such as a photograph, has been captured, the media item may be transmitted using the messaging mode. The user may capture a photograph and transmit the photograph using, for example, an MMS message protocol. The media item may be transmitted across a network to a server (e.g., external device 102) and/or one or more additional user devices (e.g., mobile devices 106). For example, media item 304 may be an image captured using a camera (e.g., camera 210), and transmitted over a network (e.g., network 104) to a server (e.g., external device 102). In some embodiments, the server may be a part of a survey generation and collection service, which may ask consumer participants to send media items that pertain to certain events. For example, a participant may be asked to send a picture corresponding to a meal they have eaten. Media item 304 may be a captured image of the participant's dinner or other meal, and the participant may transmit media item 304 within message 308 to the survey generation and collection service. In some embodiments, the users may send the media items to a specific email address and/or mailbox that may be linked or may correspond to a particular survey group or survey study.

FIG. 4A is an illustrative diagram of a display for sending media items and for receiving a link to a generated survey in accordance with various embodiments. Display 400 may display a communications mode of the mobile device, such as messaging mode as shown in region 402. In some embodiments, the communications mode may correspond to an MMS/SMS messaging mode, an email mode, or a third party messaging application mode, or any other messaging mode.

In some embodiments, a user may transmit media item 404 via message 406 to an external device, another mobile device, and/or a social media provider. Media item 404 and message 406 may, in some embodiments, be substantially similar to media item 304 and message 306 shown in FIG. 3B, in which case, the previous description may apply. In some embodiments, in response to having sent message 406, the user may receive message 408. In some embodiments, message 408 may be substantially similar to message 406, with the exception that message 408 may be received by the user's mobile device and message 408 may also include URL link 410. Link 410 may allow the user to access a survey including one or more survey questions. In some embodiments, by pressing link 410, a web browser on the mobile device may open, and the user may be directed to the generated survey via the URL link. In some embodiments, pressing link 410 may open a dedicated application on the mobile device that allows the user to access link 410 from within the application. In some embodiments, the media item(s) may be emailed to a specific mailbox, which in turn may send the survey and/or a link to the survey to the user.

In some embodiments, the user may respond to the one or more survey questions provided by link 410. For example, link 410 may load the survey within a web browser on the user device, and the user may respond to the one or more survey questions from within the web browser. In some embodiments, the received media items may also be displayed within the survey accessed via link 410. However, in some embodiments, the media item may also be provided within message 408. For example, the user may receive message 408 including both the transmitted media item(s) 404 and link 410 to the generated survey.

FIG. 4B is an illustrative diagram of a display for sending and receiving media items in accordance with various embodiments. Display 400 may display a communications mode of the mobile device, such as messaging mode 402, as well as media item 404 transmitted via message 406. In some embodiments, message mode 402, media item 404, and message 406 of FIG. 4B may be substantially similar to message mode 402, media item 404, and message 406 of FIG. 4A, in which case, the previous description may apply. In some embodiments, the communications mode may correspond to an MMS/SMS messaging mode, an email mode, or a third party messaging application mode, or any other messaging mode. However, persons of ordinary skill in the art will recognize that the media items may not be required to be presented, and the survey may be transmitted solely within image 408.

Message 408, for example, may be any message received by the user, and may include media item 408a and survey questions 408b and 408c. In some embodiments, media item 408a may be substantially similar to media item 404. This may aid in triggering the user's memory that they transmitted the media item, and one or more survey questions may be received in response to their transmission. Furthermore, the media item may stimulate the user's memory of the event when they answer the survey questions.

Survey questions 408b and 408c may be any type of survey question selected by a survey generation service in response to receiving transmitted media item 404 via message 406. In some embodiments, the survey generation service may select the one or more survey questions based on the actual content of the media item transmitted. For example, if the user transmits an image of a pasta dinner, one or more survey questions may be selected that generally correspond to the pasta dinner or to Italian food. Persons of ordinary skill in the art will recognize that this is merely exemplary, and that any survey question or questions may be selected based on any number of attributes associated with the media item.

In some embodiments, the user may have a profile registered on the server including user information. In response to receiving the media item(s), one or more survey questions may be selected and sent to the user within message 408 based on the user information ascertained from the user's profile. Furthermore, the user's profile may log all of the user's communications with the survey generation service, and select one or more survey questions based on one or more past survey question responses.

In some embodiments, the external device may automatically monitor for incoming media items. For example, the external device may include a processor (e.g., processor 202), which may be capable of discerning the content of the incoming communications from the mobile devices. The external device may use any suitable algorithm and/or code to analyze the media items and/or incoming communications. For example, the external device may detect a subject line of incoming email messaging, and from the subject line select one or more survey questions for the survey. The external device may additionally store any incoming communications in one or more centralized databases for future reference and/or analysis.

In some embodiments, the user may receive a survey from the survey generation and collection service automatically in response to transmitting the media item to the server. For example, a user capturing a photograph of their pasta dinner may transmit the photograph to the server via a messaging mode. In response, a survey may be selected that includes one or more survey questions and/or the transmitted media item and the one or more survey questions. Use of the media item in conjunction with the one or more survey questions can aid in triggering the user's memory, and provide a higher likelihood of a useful response to survey questions, however this may not be required. The media item(s) and question(s) combination may stimulate the user's memory of the event with which the user captured and/or obtained the media item or items and transmitted them, such that the survey response is more accurate and beneficial. However, persons of ordinary skill in the art will recognize that this may not have to occur, and due to the relatively short time delay between sending the image and receiving the survey, the user's memory may not require triggering.

In some embodiments, after receiving the survey, the user may transmit responses for the one or more survey questions using any suitable communications mode. For example, the user may transmit responses to the survey question(s) via a same messaging mode that was used to receive the survey (e.g., an MMS message). In some embodiments, the user may respond to the survey questions using one or more different modes. For example, the user may receive the survey via an MMS message, but may respond to the survey questions via an email.

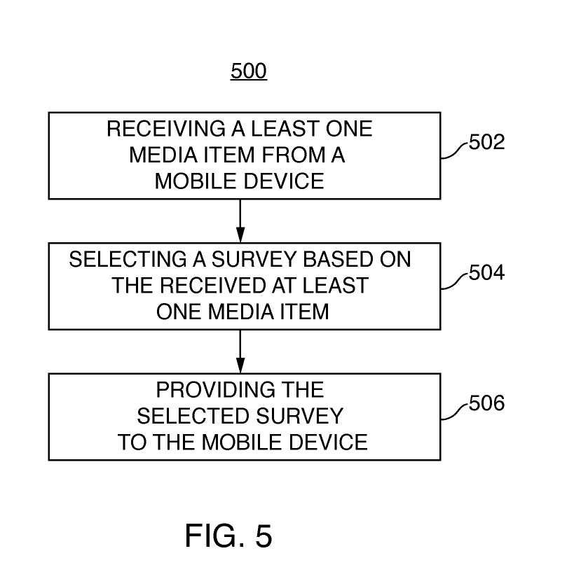

FIG. 5 is an illustrative flowchart of a process 500 for providing a survey in accordance with various embodiments. Process 500 may begin at step 502. At step 502, one or more media items from the mobile device may be received by the external device. In some embodiments, the mobile device may transmit the media item(s) to the external device across a network. For example, external device 102 may be a server corresponding to a survey generation and collection survey and may receive one or media items from mobile device 106 via network 104. In some embodiments, the one or more media items may include photographs, videos, audio (e.g., voice recordings and/or music files), text messages, documents (e.g., text documents, spreadsheets, presentations), or any other type of media item, or any combination thereof.

The external device may receive the media item(s) via any suitable communications mode. For example, the media item(s) may be received via short message service (“SMS”) messages, multi-media message service (“MMS”) message, an instant message, a third party application message, an email, or any other messaging service, or any combination thereof. The external device may be operable to receive data from the network using resident communications circuitry. The communications circuitry may allow the network to transmit the media item using any suitable communications protocol including, but not limited to, Wi-Fi (e.g., a 802.11 protocol), Bluetooth®, radio frequency systems (e.g., 900 MHz, 1.4 GHz, and 5.6 GHz communications systems), infrared, GSM, GSM plus EDGE, CDMA, quadband, VOIP, or any other protocol, or any combination thereof.

At step 504, a survey may be selected based on the one or more received media items. The survey may, in some embodiments, include one or more survey questions and/or one or more media items and one or more survey questions. In some embodiments, the survey may be selected by the external device. For example, the external device may correspond to a server that may generate surveys and compile and/or analyze survey responses. In some embodiments, the one or more survey questions may be selected from a plurality of survey questions. The external device may include instructions to randomly select certain survey questions, select survey questions related to a specific topic or topics, and/or select questions based on any predefined rule. Any number of survey questions may be included within the survey.

In some embodiments, the one or more media items may be presented at the beginning of the generated survey. Displaying the media item(s) at the beginning of the survey may aid in triggering the user to respond to the survey question(s). The media item may be included anywhere within the survey. In some embodiments, the media item may be presented at multiple points within the generated survey to maintain the user's focus on the survey.

In some embodiments, upon receiving the one or more media items, the external device may analyze the media item(s) for one or more attributes. For example, the external device may determine the type of media item that has been transmitted and/or one or more attributes associated with the media item. In some embodiments, the external device may include one or more algorithms that may analyze the media item to determine the content of the media item. For example, if the media item is a photograph of a pasta dinner, the external device may run one or more algorithms to determine that the photograph includes an image of a pasta dish and/or any other features/attributes associated with the image. As another example, the media item(s) may include one or more pieces of metadata that may be detected by the external device.

In some embodiments, the survey questions may be selected based on the received media item. Continuing the example previously described, the external device may detect that the received photograph includes a pasta dish and may select one or more survey questions based on the this. For example, the survey questions may relate to the brand of pasta and/or sauce used, how often the user has this meal, or any other type of question. However, persons of ordinary skill in the art will recognize that the use of one or more survey questions based on the media items content is merely exemplary, and any survey question may be selected regardless of the media item's content.

At step 506, the selected survey may be provided to the mobile device. In some embodiments, an external device may transmit a URL link for the survey to the mobile device over the network. For example, link 410 may be transmitted to the mobile device via message 408. In some embodiments, the URL link may load the survey in an internet browser on the mobile device. In some embodiments, the URL link may open the survey within a dedicated application for the survey that may interface with the external device.

In some embodiments, the external device may transmit the survey to the mobile device over a network. Any communications mode may be used to transmit the survey to the mobile device including, but not limited to, SMS messages, MMS messages, email messages, instant messages, third party application messages, and/or via a uniform resource locator (“URL”) link that may direct the user to the survey, or any other messaging means, or any combination thereof. In some embodiments, the external device may direct the user to log-in to a website that includes the survey. In some embodiments, the same communications mode that the user used to transmit the media item to the external device may be used to send the survey to the user's mobile device. For example, the user may send image 304 of FIG. 3B to the external device via message 306. In response to receiving message 308, external device 102 may transmit the survey back to the user's mobile device via message 408 of FIG. 4.

In some embodiments, process 500 may additionally include the external device receiving a response to the generated survey from the mobile device. The response may include one or more answers to the one or more survey questions provided within the survey. In some embodiments, the response may be sent from the mobile device to the external device using the same communications mode with which the survey was provided to the mobile device. For example, if survey has been provided to the mobile device via a MMS message, the one or more responses to the survey questions may be received by the external device via an additional MMS message. In some embodiments, one or more responses to the survey questions may be received via a submission to a web page or a form included within a web page. Each response to each survey question may be sent in separate messages and/or within one message. In some embodiments, the response received by the external device may differ in type than that that with which the survey was provided. For example, if the survey had been provided to the mobile device via an MMS message, the response to the survey may be received by the external device via an email.

In some embodiments, process 500 may additionally include the external device analyzing the one or more media items received from the mobile device for one or more attributes. The one or more media items may include any number of attributes including, but not limited to, metadata tags, share indicators, time and/or date stamps, or any other attribute, or any combination thereof. In some embodiments, the external device may analyze the one or more media items using any suitable analysis method and/or algorithm. For example, the external device may use an image analysis algorithm, a video analysis algorithm, an audio analysis algorithm, or any other algorithm, or any combination thereof. The external device may perform the algorithm(s) on the one or more media items to determine if any attributes are included with the media item(s). For example, the external device may receive a photograph from the mobile device and, in response, run an image analysis algorithm on the photograph to determine the photographs contents and/or subject matter. If the photograph includes an image of a person, for example, the image analysis algorithm may detect the person and determine whether or not that person corresponds to a contact of the user. One or more survey questions may then be selected accordingly based on the detection.

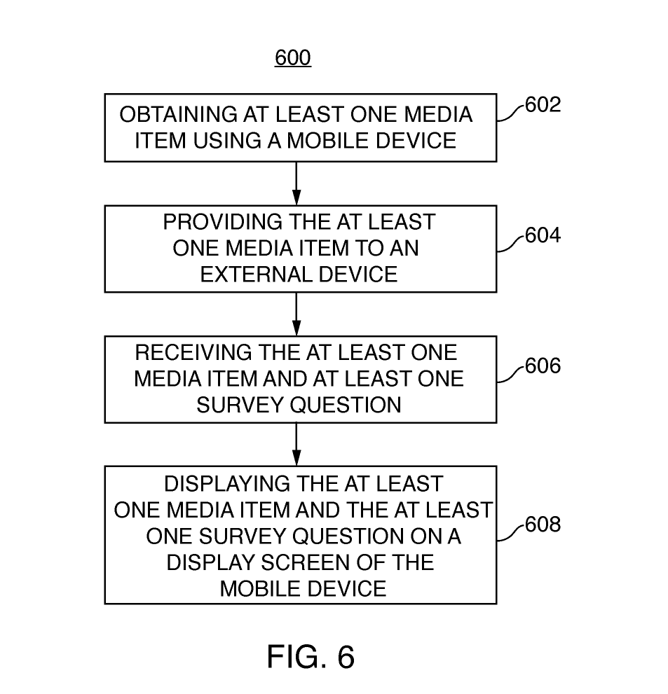

FIG. 6 is an illustrative flowchart of a process for a mobile device to receive and display a survey in accordance with various embodiments. Process 600 may begin at step 602. At step 602, one or more media items may be obtained using a mobile device. For example, device 200 may include camera 210, which may capture one or more photographs. In some embodiments, the mobile device may correspond to a user's mobile device who may be a registered to participate and respond to surveys from an external device (e.g., a server that generates surveys). For example, external device 102 may correspond to a server that generates and collects surveys, and may send surveys to registered participants. Participants may be requested to obtain media items by the server for the surveys.

In some embodiments, the one or more media items may be obtained from a social media provider. For example, a user may obtain one or more photographs from a user's social media provider profile and/or a social media provider profile of a contact of the user. In some embodiments, the one or more media items may be obtained from storage within a user's mobile device. For example, storage 206 on device 200 may include one or more photographs and/or videos that may be used.

At step 604, the one or more media items obtained using the mobile device may be provided to an external device. In some embodiments, the external device may a server. In some embodiments, the external device may be a mobile device. For example, a user of mobile device 106 may obtain a media item and may provide the media item to another user's mobile device 106. In some embodiments, the mobile device may provide the media item or items to the external device across a network. For example, mobile device 106 may provide the one or more media items to external device 102 via network 104.

The one or more media items may be provided to the external device using any suitable communication mode. Various types of communication modes may include, but are not limited to, MMS messages, SMS messages, emails, instant messages, third party application messages, or any other message type, or any combination thereof. In some embodiments, the mobile device may provide a URL link to the external device that includes the one or more media items and/or access to the one or more media items. In some embodiments, the user may obtain the one or media items and provide them to the external device using one or more gestures and/or invocations. For example, a user may obtain a photograph from within a photo album on the user's mobile device and send the photograph to the external device from within the photo album.

At step 606, the mobile device may receive the one or more media items and one or more survey questions from the external device. In some embodiments, the external device may generate a survey in response to being provided with the one or more media items, and the survey may include the one or more media items and one or more survey questions. For example, a user may provide a photograph of a pasta dinner to an external device. In response, the external device may send the user a survey on the user's mobile device that includes the photograph of the pasta dinner and one or more survey questions. In some embodiments, the media item and the one or more survey questions may be sent to the user via a URL link to the generated survey. For example, the user may receive a message including a link directing the user to a website providing the generated survey. In some embodiments, the media item or items may be included within the message sent to the user and/or within the generated survey accessed via the URL link. In some embodiments, the one or more survey questions may be selected based on the media item(s) provided. For example, if the user provides the photograph of the pasta dinner, the one or more survey questions may correspond to the pasta dinner. In this scenario, survey questions may include, for example, “What brand of pasta are you using?” or “Did you enjoy the pasta dinner?”.

In some embodiments, the one or more media items and the one or more survey questions may be simultaneously displayed on a display screen of the mobile device. For example, media item 408a and survey questions 408b and 408c may all be displayed within message 408 on a user's mobile device display. This may aid in triggering the user to respond to the survey questions because they may recognize this image that they provided to the external device to generate the survey and may stimulate the user's memory of the events corresponding to the media item.

In some embodiments, the one or more media items and the one or more survey questions may be received from the external device by the mobile device using any suitable communications means. For example, the user may receive an SMS message, an MMS message, an instant message, one or more third party application messages, or any other type of message, or any combination thereof, which may include the received media item(s) and survey question(s) therein. In some embodiments, the user may receive a URL link that may direct the user to a dedicated webpage including the one or more media items and the one or more survey questions. In some embodiments, the user may receive a document or file that may be downloaded onto the user's mobile device. Once downloaded, the user may view the one or more media items and the one or more survey questions within the downloaded file. For example, the survey may be in an executable program, and the mobile device may receive a download for the executable program. After the user downloads the file, the user may launch the program to view the one or more media items and the one or more survey questions.

At step 608, the one or more media item and the one or more survey question may be displayed on a display screen of the mobile device (persons of ordinary skill in the art will appreciate that the media item may include multiple items and the survey question may include multiple questions without departing from the spirit of the present invention). For example, device 200 may include display 204, which may show the media item and the survey question(s). In some embodiments, both of the media item(s) and the survey question(s) may simultaneously be displayed on the display screen of the mobile device.

In some embodiments, the mobile device may send a response for the one or more survey questions back to the external device. The response(s) may be sent using any suitable means of communications. In some embodiments, the mobile device may send the response(s) via the same mode of communications that the one or more survey questions and one or more media items were received with. For example, the user may receive media item 408a and survey questions 408b and 408c within message 408, which may be an MMS message. The user may send a response back to the survey questions via another MMS message. In some embodiments, the user may send separate messages for each survey question.

In some embodiments, the user may send a response back to the external device that includes one or more additional media item. For example, the user may respond to the survey question “What brand of pasta are you having?” with an image of a product from the pasta company that produces the pasta. In some embodiments, the user may respond to the one or more survey questions with contact information of a contact associated with the user. For example, one of the survey questions may be “Do you know anyone who would want to participate in our survey?” In response, the user may provide a contact's email, phone number, vcard, or any other piece of contact information that would allow the external device to contact the user's contact.

In some embodiments, the user may provide information to one or more social media networks regarding the response to the one or more survey questions. This may enable additional contacts associated with user to become aware of the survey and potentially participate. In some embodiments, the user may be rewarded for additional contacts that join the survey system and/or for sharing the survey information. For example, the user may receive message 408 including media item 408a and survey questions 408b and 408c. Within message 408 there may also be a sharing button that may enable the user to share the survey questions, the survey topic, the external device's contact information, or any other piece of information, with one or more social media networks with which the user participates. This may aid in spreading the knowledge of the survey to additional people to increase response statistics and participation.

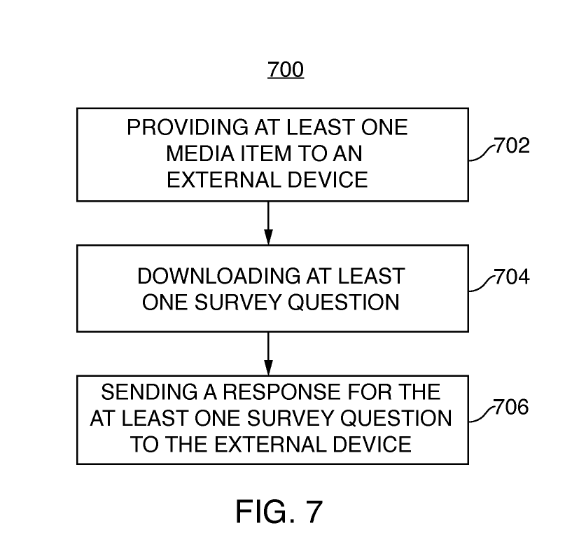

FIG. 7 is an illustrative flowchart of a process 700 for sending response to survey questions in accordance with various embodiments. Process 700 may begin at step 702. At step 702, one or more media items may be provided to an external device. In some embodiments, a user's mobile device, such as mobile device 106 of FIG. 1, may provide a media item or items to external device 102. In some embodiments, the mobile device may include a processor, such as processor 202 of FIG. 2, which may include instructions to provide and how to provide the media item(s). In some embodiments, step 702 of FIG. 7 may be substantially similar to step 604 of FIG. 6, in which case, the previous description should apply here as well.

At step 704, one or more survey questions may be downloaded by the mobile device. For example, survey questions 408b and 408c may be received by a mobile device on display 400 as shown in FIG. 4. In some embodiments, both the provided media item(s) may be downloaded in addition to the survey questions. The media item(s) and the survey question(s) may be simultaneously displayed on a display screen of the mobile device. In some embodiments, the media item(s) and/or the survey question(s) may be received at separate time intervals. For example, the mobile device may receive the media item first and then the survey question(s) later. In some embodiments, the mobile device may receive the media item or items, along with an invitation to receive the corresponding survey question or questions. In some embodiments, step 704 of FIG. 7 may be substantially similar to step 606 of FIG. 6, in which case the previous description applies.

At step 706, a response for the survey question(s) may be sent to the external device. In some embodiments, the user of the mobile device may send a response back to the survey questions via the same communications mode as that with which the survey questions were received. For example, server 102 may send the one or more media items and the one or more survey questions to the mobile device via an MMS message. The user may then respond to the one or more survey question by sending one or more MMS messages to the external device. This, however, is merely exemplary, and any communications mode may be used to receive and respond to the one or more survey questions.

The various embodiments described herein may be implemented using a variety of means including, but not limited to, software, hardware, and/or a combination of software and hardware. The embodiments may also be embodied as computer readable code on a computer readable medium. The computer readable medium may be any data storage device that is capable of storing data that can be read by a computer system. Various types of computer readable mediums include, but are not limited to, read-only memory, random-access memory, CD-ROMs, DVDs, magnetic tape, or optical data storage devices, or any other type of medium, or any combination thereof. The computer readable medium may be distributed over network-coupled computer systems. Furthermore, the above described embodiments are presented for the purposes of illustration are not to be construed as limitations.

What is claimed is:

1. A method for conducting a survey, the method comprising:
receiving at least one media item from a mobile device;
selecting a survey based on the received at least one media item; and
providing the selected survey to the mobile device.

2. The method of claim 1, wherein providing the selected survey to the mobile device further comprises:
providing the at least one media item to the mobile device.

3. The method of claim 1, further comprising:
providing at least one survey question and the at least one media item to the mobile device.

4. The method of claim 1, further comprising:
receiving a response to the selected survey from the mobile device.

5. The method of claim 4, wherein the response comprises at least one answer to at least one survey question from the survey.

6. The method of claim 1, wherein providing the selected survey comprises:
displaying both the at least one media item and at least one survey question from the survey on the mobile device.

7. The method of claim 1, wherein the at least one media item comprises at least one of:
a photograph;
a video;
audio; and
text.

8. The method of claim 1, wherein receiving comprises receiving the at least one media item via at least one of:
a short message service (“SMS”) message;
a multi-media message service (“MMS”) message; and
an instant messaging service message.

9. The method of claim 1, wherein providing the selected survey comprises sending the selected survey to the mobile device using at least one of:
a short message service (“SMS”) message;
a multi-media message service (“MMS”) message; and
an instant messaging service message; and
a uniform resource locator (“URL”) link.

10. The method of claim 1, further comprising:
analyzing the received at least one media item for at least one attribute.

11. The method of claim 10, wherein the analysis is performed using at least one of:
an image analysis algorithm;
a video analysis algorithm; and
an audio analysis algorithm.

12. The method of claim 1, wherein selecting the survey comprises generating the survey based on an analysis of the at least one media item.

13. The method of claim 1, wherein selecting the survey comprises:
selecting at least one survey question from a plurality of predefined survey questions; and
creating the survey with the selected at least one survey question.

14. The method of claim 13, wherein selecting the at least one survey question comprises selecting the at least one survey question based on at least one profile characteristic of a user associated with the mobile device.

15. A method comprising:
obtaining at least one media item using a mobile device;
providing the at least one media item to an external device;
receiving, from the external device, at least one survey question; and
displaying the at least one survey question on a display screen of the mobile device.

16. The method of claim 15, wherein receiving the at least one survey question further comprises:
receiving the provided at least one media item.

17. The method of claim 15, wherein displaying the at least one survey question on the display screen further comprises:
displaying the provided at least one media item on the display screen of the mobile device.

18. The method of claim 17, wherein the at least one media item and the at least one survey question are simultaneously displayed on the display screen.

19. The method of claim 15, further comprising:
sending a response for the at least one survey question to the external device.

20. The method of claim 19, wherein sending the response comprises sending at least another media item to the external device.

21. The method of claim 20, wherein the at least another media item comprises contact information of a contact associated with a user of the mobile device.

22. The method of claim 15, further comprising:
providing information regarding a response for the at least one survey question to at least one social media provider.

23. The method of claim 15, wherein obtaining the at least one media item comprises at least one of:
obtaining the at least one media item using an image capturing component resident on the mobile device; and
retrieving the at least one media item from a social media provider.

24. The method of claim 15, wherein the external device comprises a server.

25. A non-transitory computer readable medium containing instructions that, when executed by at least one processor of a mobile device, cause the mobile device to:
provide at least one media item to an external device;
download, from the external device, a survey comprising at least one survey question; and
send a response for the at least one survey question to the external device.

26. The non-transitory computer readable medium of claim 25, when executed by the at least one processor of the mobile device, further causes the mobile device to:
present, on a display screen of the mobile device, the provided at least one media item and the survey.
